(19) United States
(12) Patent Application Publication
(10) Pub. No.: US 2004/0018875 A1
(43) Pub. Date: Jan. 29, 2004

(54) Premium acquisition game system utilizing communication network, and premium acquisition game host computer and player terminal both used in that system

(76) Inventor: Kazuyoshi Shimoda, Tokyo (JP)

Correspondence Address: HARNESS, DICKEY & PIERCE, P.L.C., P.O. BOX 828, BLOOMFIELD HILLS, MI, 48303, US

(21) Appl. No.: 10/333,550

(22) PCT Filed: Jan. 21, 2002
(86) PCT No.: PCT/JP02/00382

(30) Foreign Application Priority Data
Jan. 26, 2001 (JP) 2001-19111

(51) Int. Cl. A63F 13/00

(52) U.S. Cl. 463/40

(57) ABSTRACT

A prize-obtaining game system utilizing a communication network where a prize-obtaining game in a game center may be virtually enjoyed on a personal computer, and an obtained prize may be surely handed to a player without being out of stock. When a host computer (2) connected to many player terminals (4) via the communication network (6) receives a game-start notification from the terminal (4), the host computer: acquires an allottable number of virtual prizes for the terminal (4) based on an actual-prize stock information from a database; allots the virtual prizes with a predetermined number, equal to or less than the allottable number, as an actual allotted number; and permits the terminal (4) to start the game. The actual allotted number is subtracted from the allottable number. With the game-end notification from the terminal (4), the computer (2) registers an obtained number of the virtual prizes to the database, and adds the unobtained number to the allottable number so that it becomes an allottable number to be used hereafter.

### TECHNICAL FIELD

The present invention relates to a virtual prize-obtaining game system where a prize-obtaining game, including a catcher game set up in a game center or the like, may be virtually enjoyed on a computer. In particular, the present invention relates to a prize-obtaining game system in which an actual prize corresponding to a virtual prize obtained by a player by utilizing a communication network may be certainly provided to the player, and a host computer and a player terminal for a prize-obtaining game used for the system.

### BACKGROUND ART

Recently, in an amusement facility including a game center, a prize-obtaining game referred to as a so-called catcher game is becoming popular. This prize-obtaining game is a game where one prize out of many prizes stored in a transparent surrounding showcase is carried to a predetermined exit and let out of the case and obtained. The prizes include such as various popular character dolls. In transferring the prizes, a manipulator which may hold the prize between both sides like a human hand is used. This manipulator is provided in the same showcase as the prize and operated by an operation button provided outside the showcase. The movement of the manipulator is normally in at least two directions chosen out of front and back, left and right, up and down, or diagonal, and there is only one chance to move in each direction, and when the pressed operation button is let go, the manipulator cannot be moved in that same direction again.

A player looks inside the showcase from the outside and operates the operating button to move the manipulator to a position where a targeted prize that the player wants may be obtained. If the manipulator stops at an appropriate position, the targeted prize is picked up from both sides by the manipulator, carried to the predetermined exit where the prize is dropped and let outside.

On the other hand, recently, with a remarkable development of the Internet and the like, a communication network environment is being rapidly arranged. Further, with an increase in data communication speed, it is becoming possible to transmit an enormous amount of data in a short time. From such circumstances, online games such as the “game of go” and chess are becoming widely popular on the Internet. One reason of the wide popularization of online games is the convenience that the game may be enjoyed freely anywhere at anytime. The game may be readily enjoyed such as at home without especially having to go to the game center or the like.

From such circumstances, the present inventor supposed that if the prize-obtaining game such as the above described catcher game can be made to be enjoyed similarly to other games on the Internet, it will gain popularity and everyone will want to try it once. In particular, since there is no need to go to a game center or the like, anyone may enjoy it anywhere, as well as eliminating regional differences.

However, in order to be able to enjoy the prize-obtaining game similarly to other games on the Internet, there are problems that have to be solved. Such a problem relates to how to manage a stock of the prizes. When enjoying the prize-obtaining game at such as the game center, since the prize actually exists in the catcher game machine or the like, if the player obtains the prize, the prize will be certainly handed to the player. However, when a prize-obtaining game is to be realized on the Internet, the prize strictly exists only virtually, so that even if the prize is actually obtained in the game, there may be a case where there is no stock of the prize and the prize cannot be handed to the player immediately. There are many players who wish to play a game relating to a prize featuring a particularly popular character or a rare prize with little stock, and there is a high possibility that there will be many people obtaining a prize in a short period of time. In such a case, there may be shortage in stock of the prizes causing delay in delivering the prize to the player, or even worse, the prize may not be received at all. Further, if the obtained prize is replaced by other prizes, the prize may not be received even though the prize is obtained with considerable effort, and thus, the player may become doubtful or even lose interest.

The present invention is made in view of the above conventional problems, and an object thereof is to provide a prize-obtaining game system utilizing a communication network in which a prize-obtaining game provided in such as a game center may be virtually enjoyed by a personal computer or the like at home and in which a prize obtained in a game is surely and without delay handed to a player, and a host computer and a player terminal for a prize-obtaining game used for the system.

### DISCLOSURE OF INVENTION

According to a first aspect of a present invention in order to accomplish the above object, a prize-obtaining game system utilizing a communication network comprises a host computer connected to many player terminals in a manner mutually capable of communicating therewith via the communication network. The player terminal executes a virtual prize-obtaining game program. The system provides to players an actual prize corresponding to a virtual prize obtained by the players in the virtual prize-obtaining game, wherein:

(11) the host computer comprises:

a stock-management database to which stock information of the actual prize is registered, and

virtual-prize allotting means for allotting a predetermined number of the virtual prize successively to the player terminal which accessed the host computer, based on the stock information registered to the stock-management database;

(12) the stock information includes:

stock number data indicating a stock number of the actual prize that can be provided to the player, and

allotted number data indicating a number of the virtual prize which is currently being allotted to the player terminal;

(13) when the host computer receives a game-start notification from the player terminal, the host computer determines whether or not the virtual prize is allottable to the player terminal based on a number of the virtual prize currently allottable, the number being calculated based on the stock number data and the allotted number data; and

when it is determined to be allottable,

the host computer sends game-start-permit information to the player terminal in order to respond to the player terminal; and

the virtual-prize allotting means updates the allotted number data registered to the stock-management database according to a number of the virtual prize to be allotted to the player terminal; and

(14) when the host computer receives a game-end notification from the player terminal, the virtual-prize allotting means acquires

information relating to a number of the virtual prize obtained by the player in the virtual prize-obtaining game executed at the player terminal, and

information relating to a number of the virtual prize allotted to the player terminal, and updates the stock number data and the allotted number data in the stock-management database based on these two information (claim 1).

According to a second aspect of the present invention, a prize-obtaining game system utilizing a communication network, comprises a host computer connected to many player terminals in a manner mutually capable of communicating therewith via the communication network. The player terminal executes a virtual prize-obtaining game program. The system provides to players an actual prize corresponding to a virtual prize obtained in the virtual prize-obtaining game, wherein:

(21) the host computer comprises:

a stock-management database for managing a stock of the actual prizes, and

virtual-prize allotting means for allotting a predetermined number of the virtual prize successively in respect to the player terminal which accessed the host computer based on stock information of the actual prizes recorded in the stock-management database;

the stock information including

a total supply number data and an already-obtained number data of the actual prize, and

an allotted number data indicating a current allotment as a virtual prize in respect to the player terminal;

(22) the host computer successively receives a game start notification from the player terminal; and

when the host computer receives the start notification, the host computer:

refers to the stock information of the stock-management database;

with the virtual-prize allotting means, calculates an allottable number of the virtual prizes which may be allotted in respect to the virtual prize-obtaining game which is executed at the player terminal based on the total supply number data, the already-obtained number data of the actual prize, and the allotted number data;

sets a predetermined number which is equal to or less than the allottable number as an actual allotted number;

transmits game-start-permit information permitting a start of the virtual prize-obtaining game according to the actual allotted number of the virtual prizes, in order to respond to the player terminal; and

adds the actual allotted number at this time to and updates the allotted number data; and

(23) the host computer successively receives from the player terminal a game-end notification including

obtained-number information of the virtual prizes obtained in the virtual prize-obtaining game executed at the player terminal, and

information for specifying the actual allotted number set at a start of the game; and

when the game-end notification is received, the host computer

adds the obtained number to and updates the already-obtained number data of the stock-management database with the virtual-prize allotting means, and

subtracts the actual allotted number from the allotted number to update the allotted number data (claim 2).

In such a system, the host computer notifies the player terminal not to start a game, when the allottable number is 0 (claim 3).

Further, in such a system, a plurality of kinds of the actual prizes are prepared, stock information of the respective kinds is recorded respectively in the stock-management database, and a game-start-permit notification is sent to the player terminal when the host computer allots at least one kind of the virtual prize in respect to the virtual prize-obtaining game executed at the player terminal, and allotting of the virtual prize of at least one kind is possible (claim 4).

Further, the host computer comprises means for storing information relating to a kind and amount of an allotted virtual prize in respect to the virtual prize-obtaining game executed at each of the player terminal, taking a player ID of each player or a terminal ID of each player terminal which are set in advance as a key (claim 5).

Further, the host computer comprises a function of sending a program of the virtual prize-obtaining game to the respective player terminal via the communication network (claim 6).

The host computer comprises: means for acquiring information necessary for delivery of the prize such as a name, an address, and a telephone number of the player who has obtained the prize; and means for registering the information in a prize delivery database (claim 7).

The host computer is a Web server arranged on the Internet; and the player terminal is a Web terminal connectable to the Internet and in which a browser software enabling browsing of information browsable on the Internet is installed (claim 8).

Further, a host computer for a prize-obtaining game according to the present invention is used as the host computer in the above-mentioned prize-obtaining game system (claim 9).

Furthermore, a player terminal for a prize-obtaining game according to the present invention is used as the player terminal in the above-mentioned prize-obtaining game system (claim 10).

### BRIEF DESCRIPTION OF DRAWINGS

FIG. 1 is a basic structural view of a prize-obtaining game system utilizing a communication network according to the present invention;

FIG. 2 is a diagram showing an embodiment of a game screen in a virtual prize-obtaining game of a prize-obtaining game system utilizing a communication network according to the present invention;

FIG. 3 is a data structural view showing an example of registration contents of a stock-management database of a prize-obtaining game system utilizing a communication network according to the present invention;

FIG. 4 is an explanatory view schematically explaining a data exchange between a host computer and a player terminal of a prize-obtaining game system utilizing a communication network according to the present invention;

FIG. 5 is an explanation diagram showing the relationship between the allottable number of virtual prizes, the total supply number data of actual prizes, and the already-obtained number data, registered in a stock-management database of a prize-obtaining game system utilizing a communication network according to the present invention;

FIG. 6 is an explanation diagram showing the relationship between the stock number data, the allotted number data, and the allottable number data registered to a stock-management database of a prize-obtaining game system utilizing a communication network according to the present invention; and

FIG. 7 is a system structural view schematically showing a system configuration of a prize-obtaining game system utilizing a communication network of the present invention structured by utilizing the Internet.

### BEST MODE FOR CARRYING OUT THE INVENTION

===Basic Structure of System===

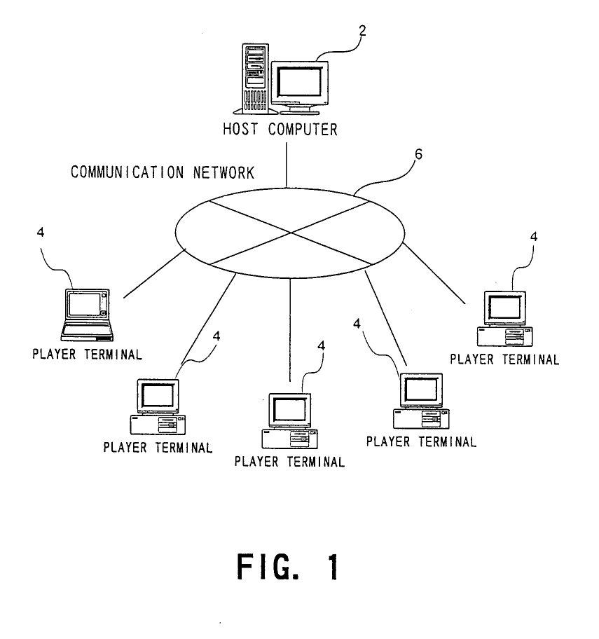

FIG. 1 is a diagram showing a basic structure of a prize-obtaining game system utilizing a communication network according to one aspect of the present invention. This system comprises a host computer 2 and many player terminals 4 connected to each other to be able to communicate via a communication network 6.

The host computer 2 is a computer system comprising, for example, a communication interface and/or a large capacity data storage device, and reads a program stored in, for example, the large capacity data storage device, and executes data processing according to the program. The host computer 2 is constructed of, for example, a high performance computer of a workstation class, and may simultaneously communicate with many player terminals 4. The host computer 2 is not limited to be structured by one computer device, and may be structured of two or more computers for distributed processing.

The communication network 6 includes any communication network which may connect the host computer 2 and the player terminal 4 such as the Internet, a public telephone network, a WAN, and/or private communication networks such as a VAN.

Other than the above, the communication network 6 according to the present invention includes various communication line networks which are closed to external sources, such as a private LAN structured for example within buildings such as hotels, or, an intranet structured within stores such as family restaurants, fast-food stores and/or convenience stores, or structured to provide connection between the shops.

The player terminal 4 includes, for example, a personal computer, or a so-called PC, provided in each home, a compact portable communication terminal such as a portable telephone or a PDA (personal digital assistant), and a home video game machine, for example, ‘Playstation’ (product of Sony Corporation) (registered trademark), ‘Dream Cast’ (product of Sega Corporation) (registered trademark), ‘Nintendo 64’ (product of Nintendo Co., Ltd.) (registered trademark), or the like. Regarding the player terminal 4, it may be any kind of terminal as long as it is accessible to the host computer 2 via the communication network 6. Furthermore, the player terminal 4 may be provided as a game machine in an amusement facility including a game center.

Other than the above, the player terminal 4 according to the present invention includes, for example: guest-room terminals provided within guest rooms in, for example, hotels; or, various information terminals provided within stores such as family restaurants, fast-food stores and/or convenience stores.

The player terminal 4 comprises: communication control means for performing communication with the host computer 2; operation input means for receiving operation input from the player; screen display means such as a CRT or a liquid crystal display displaying a game screen; and storage means such as a hard disk device or a memory for storing various programs or data. As an operation input means, in case of a personal computer or the like, it may comprise a keyboard or a mouse; and in case of a video game machine, it may comprise device machines such as an exclusive game controller. Each player terminal 4 is installed with a virtual prize-obtaining game program which is executed by an instruction from the player.

===Virtual Prize-Obtaining Game===

The virtual prize-obtaining game is a game having an object to be played by obtaining a virtual prize. In the present invention, there actually exists a prize which corresponds to a virtual prize, and the prize obtainer may actually be handed an actual prize which corresponds to the virtual prize obtained in the game.

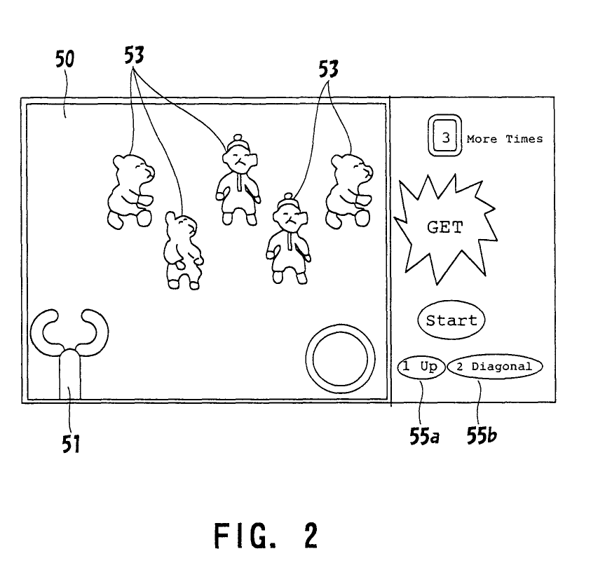

FIG. 2 shows an example of a game screen of a virtual prize-obtaining game. This virtual prize-obtaining game is a game where the virtual prize 53 displayed on a display screen of a player terminal 4 is virtually obtained with a manipulator 51 by moving an image of the manipulator 51 displayed at the left bottom of the display screen. As a virtual prize 53, there are, for example, various dolls featuring a popular character and/or confectionaries, and many kinds of the images of these virtual prizes 53 are simultaneously lined up and displayed on the same screen. The manipulator 51 may be moved in an up or down direction or a diagonal direction by two direction buttons 55a, 55b displayed at the right bottom of the display screen. The operation of each direction button 55a, 55b is performed through the operation input means of the player terminal 4. The operation of each of the direction buttons 55a, 55b may be performed only once respectively. The player moves the manipulator 51 in one operation for each direction near the virtual prize image that he/she wants, and has to stop the manipulator in an appropriate position where the prize may be obtained.

A virtual prize-obtaining game according to the present invention may be applied to any other game, for example, a shooting game, a quiz game, or the like, where a prize may be obtained when winning the game.

The virtual prize-obtaining game program is provided to each player terminals 4 by downloading via the communication network 6, or is provided by being stored in an appropriate storage medium such as a CD-ROM or a DVD-ROM. In case the program is provided via the communication network 6, there may be embodiments where the program is provided as a Java Applet (registered trademark) or the like.

Other than the above, Flash technology can also be applied to provide the virtual prize-obtaining game program according to the present invention.

===Stock-Management Database and Virtual-Prize Allotting Means===

In order to provide the player with the actual prize corresponding to the virtual prize obtained in the virtual prize-obtaining game, the host computer 2 comprises: a stock-management database managing the stock of the actual prizes; and a virtual-prize allotting means successively allotting the virtual prize a predetermined number of times in respect to the many player terminals 4 which access the host computer 2.

Here, the term “allot” means to offer, as a security to the player terminal where the prize-obtaining game is executed, a prize to be the object of obtainment, that is, an actual prize corresponding to a virtual prize shown to the player through, for example, a displaying screen on the display, as a virtual prize. Actual prizes are offered as a security according to the number of the virtual prizes provided to the player. That is, in case five virtual prizes are to be the object of obtainment in a prize-obtaining game on a player terminal, five actual prizes, corresponding to the virtual prizes, are offered as a security. The prizes offered as a security are omitted from being allotted to other player terminals, and every time the prizes are taken as a security, the number of actual prizes to be an object of security will decrease by the number that has been taken as a security. This security will not be released unless a certain condition is met, such as when the prize-obtaining game on the player terminal has ended.

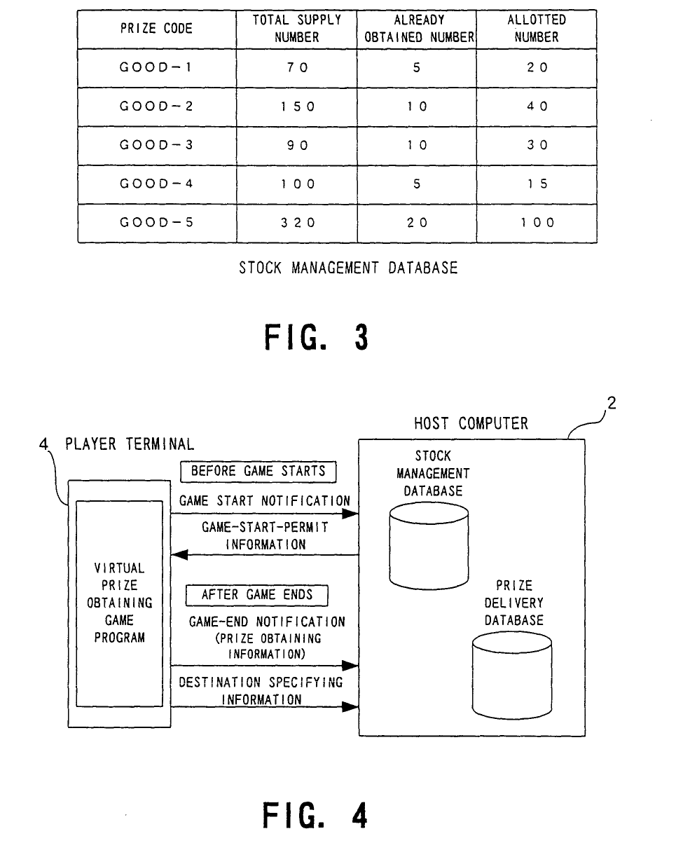

The stock-management database is registered with stock information of the actual prizes for every prize ID that is assigned to every kind of the prize in advance. Here, the stock information registered in the stock-management database is registered with a total supply number data showing the actual number of received prizes, as well as an already-obtained number data and an allotted number data. The already-obtained number data is data showing the number of prizes that exists in actuality at a stage before delivery and stored in, for example, a warehouse but has already been obtained by a player in the virtual prize-obtaining game, and thus will not be an object of allotment. Further, the allotted number data is data showing the number of the actual prizes that are currently allotted as virtual prizes in respect to one or a plurality of player terminals 4. FIG. 3 shows an embodiment of registered contents of a stock-management database.

The virtual-prize allotting means is means which is realized by a program installed in the host computer 2, and allots a predetermined number of virtual prizes successively in respect to the many player terminals 4 which access the host computer 2.

===Process of Host Computer===

<Process Before Starting Game>

FIG. 4 simply shows a data exchange between the host computer 2 and the player terminal 4. The player terminal 4 notifies the start of the game to the host computer 2 when the player starts the virtual prize-obtaining game. The host computer 2 refers to the stock information of the stock-management database when there is a notification of the start of the game from the player terminal 4, and calculates an allottable number of virtual prizes which may be allotted in respect to a virtual prize-obtaining game executed by the player terminal 4, based on the total supply number data, the already-obtained number data of the actual prizes, and the allotted number data. Then, based on the allottable number, the host computer 2 sets a predetermined number being equal to or less than the allottable number as an actual allotted number.

For example, when the total supply number data, the already-obtained number data, and the allotted number data of the stock information registered in the stock-management database is “100”, “20”, and “30”, respectively, the allottable number of the virtual prizes is “50”, since it is a number where the already-obtained number data “20” and the allotted number data “30” are subtracted from the total supply number data “100”. The actual allotted number is set to be a predetermined number of “50” or less.

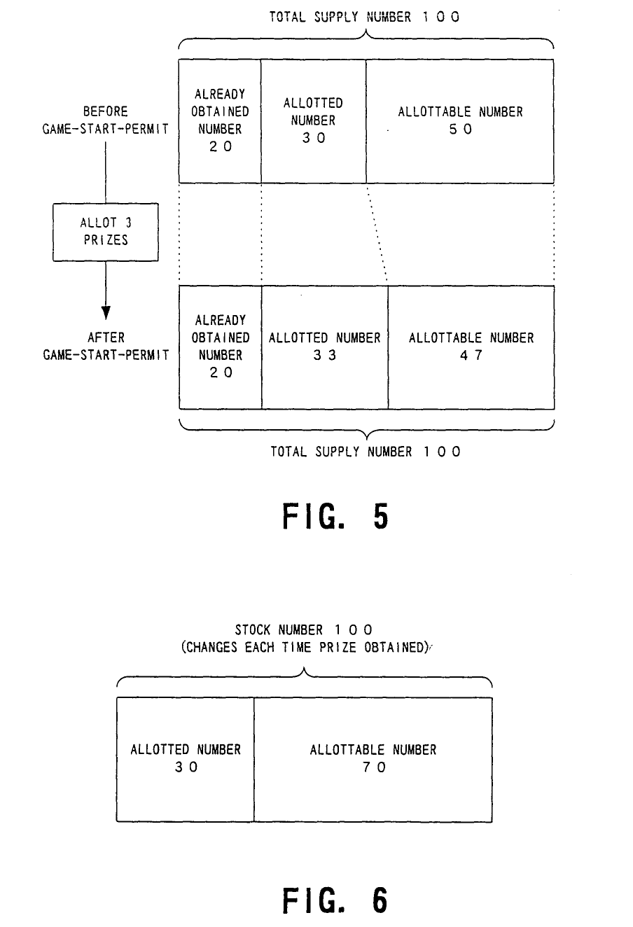

Upper part of FIG. 5 shows the relationship between the total supply number data, the allotted number data, the already-obtained number data, and the allottable number. The allottable number is a number in which the already-obtained number data and the allotted number data are subtracted from the total supply number data of the actual prize.

Note that, when there are two or more kinds of virtual prizes handled by the virtual prize-obtaining game, these calculations are all executed for each kind of prize.

The actual allotted number set here is a number of the virtual prizes handled in the virtual prize-obtaining game executed by the player terminal 4. This actual allotted number is set based on the number of the virtual prizes requested in advance by the virtual prize-obtaining game. That is, when the requested by the virtual prize-obtaining game, in principle, such requested number is set as the actual allotted number as is.

When the allottable number of the virtual prize does not reach the number requested by the virtual prize-obtaining game, the number requested by the virtual prize-obtaining game cannot be set as the actual allotted number. Thus, the allottable number, which is the maximum number that is allottable as a virtual prize at present, is set as the actual allotted number as is. When there are two or more kinds of the virtual prizes requested by the virtual prize-obtaining game, the number requested by the virtual prize-obtaining game is met by making up for the prize having a small allottable number with the prize having a larger allottable number.

Information regarding the number of the virtual prizes requested by the virtual prize-obtaining game is acquired based on information from the player terminal 4 or information registered in the database that the host computer 2 itself has in advance. When there are two or more kinds of virtual prizes requested by the virtual prize-obtaining game, the number of the virtual prizes requested by the virtual prize-obtaining game may be set for each kind of the virtual prizes, or the number may be the entire number of the virtual prizes requested by the virtual prize-obtaining game.

If the virtual prize of the virtual prize-obtaining game may be allotted, the host computer 2 sends game-start-permit information towards the player terminal 4 to respond to the player terminal 4. This game-start-permit information permits the starting of the virtual prize-obtaining game with the actual allotted number of the virtual prizes, and there is a case where this game-start-permit information includes various information such as information regarding the kind or number of the allotted virtual prize in the virtual prize-obtaining game executed at the player terminal 4, and other information regarding the virtual prizes.

Further, the host computer 2 updates the allotted number data of the stock-management database to a number added with the actual allotted number at this time, together with sending of this game-start-permit information. That is, in a case the actual allotted number is set as “3”, and the allotted number data of the stock-management database is “30”, this allotted number data is set and updated to “33” as a number where “30” is added with “3”. On the other hand, when the allottable number is “0”, the host computer 2 sends a game-unstartable notification towards such player terminal 4.

Lower part of FIG. 5 shows the change in the allotted number and the allottable number when three virtual prizes have been allotted. When three virtual prizes are allotted, the allotted number is increased by three, whereas the allottable number is decreased by three.

When the player terminal 4 receives the game-start-permit information from the host computer 2, based on such information, the virtual prize-obtaining game is started with the actual allotted number of the virtual prizes. Namely, for example, if the actual allotted numbers are set as three for the virtual prize A and four for the virtual prize B in the game-start-permit information from the host computer 2, an obtaining-target virtual prize of the virtual prize-obtaining game is set as three for the virtual prize A and four for the virtual prize B. On the other hand, the player terminal 4 which has received the game-unstartable notification from the host computer 2 conveys the notification to the player by displaying a message or the like to the effect that the virtual prize-obtaining game may not be executed.

<Process After Ending of Game>

When the virtual prize-obtaining game is ended, the player terminal 4 sends a game-end notification to the host computer 2. This game-end notification includes various information such as obtained-number information of virtual prizes which the player has obtained in the prize-obtaining game executed at the player terminal 4, and information for specifying the actual allotted number set at the start of the virtual prize-obtaining game executed at the player terminal 4. Here, the obtained-number information of virtual prizes includes information such as the number of prizes obtained by the player, and the kind of the virtual prize when there are two or more kinds of prizes. Of course, even in a case the player has not obtained a prize, information to the effect that the obtained number is “0” (zero) is sent to the host computer 2. Further, the information for specifying the actual allotted number set at the start of the virtual prize-obtaining game executed at the player terminal 4 is information for specifying the number of virtual prizes that were allotted to the virtual prize game of the player terminal 4. This information is used to cancel the allotting of the virtual prize allotted to the virtual prize game of the player terminal 4. Regarding this information, specifically there are the following two embodiments.

(1) At the start of the game, information of the actual allotted number is sent from the host computer 2 side to the player terminal 4, and at the end of the game the player terminal 4 sends this information towards the host computer 2.

(2) At the start of the game, the host computer 2 stores the actual allotted number having been set in relation with an ID assigned to each player terminal 4 or to each player in a storage section, notifies this ID to the player terminal 4, and then at the end of the game the player terminal 4 sends this ID as the above-mentioned information to the host computer 2. Based on this ID, the host computer 2 specifies the stored actual allotted number.

When the host computer 2 receives the game-end notification from the player terminal 4, the already-obtained number data of the stock-management database is updated based on the obtained-number information included in the game-end notification. Further, the host computer 2 specifies the actual allotted number from the above-mentioned information specifying the actual allotted number included in the game-end notification. This actual allotted number is subtracted from the allotted number, and the allotted number data is updated. Namely, when the obtained number of the obtained-number information included in the game-end notification is “2” and the already-obtained number data of the stock-management database is “20”, the obtained number “2” is added to the already-obtained number data “20”, thus the already-obtained number data is updated to “22”. Further, when the actual allotted number (a number of virtual prizes allotted to the player terminal 4) is “5”, and the allotted number (a number of virtual prizes currently allotted to all player terminals 4) is “30”, the actual allotted number “5” is subtracted from the allotted number “30”, and the allotted number data is updated to “25”. When there are handled two or more kinds of the virtual prizes in the virtual prize-obtaining game, these calculations are executed for each kind of all the prizes.

<Prize Delivery Process>

The host computer 2 acquires information necessary for delivering the actual prize to the hands of the player, namely, information such as a name, an address, and a telephone number of a destination, in order to send the actual prize corresponding to the virtual prize that the player has obtained. There are the following methods for the host computer 2 to acquire these information:

(1) to directly acquire information from the player himself/herself for every game through the player terminal 4; and

(2) to provide, at the host computer 2 side, a database to manage for each player the information related to the destination specified by the player in advance, and to acquire the information related to the destination of the player from such database.

The host computer 2 registers to the prize delivery database the acquired destination information together with information relating to the kind of the prize obtained by the player. The prize delivery center proceeds with the delivery operation of the actual prize based on the information registered to the prize delivery database. A delivery progress situation of the prizes are conveyed to each player by electronic mail or the like.

<Other Embodiments>

Further, in the stock-management database of the host computer, instead of the total supply number data, the already-obtained number data, and the allotted number data, there may be registered, as stock information, stock number data of the actual prizes and allotted number data indicating a number of virtual prizes currently being allotted to the player terminal(s). The host computer may carry out the allotting process of the virtual prizes based on the stock number data and the allotted number data. Here, the stock number data is data obtained by subtracting the above-mentioned already-obtained number data from the total supply number data, and is uploaded, changed and reflected in a real-time manner each time a prize is obtained by a player at the respective player terminals. The allotted number data is the same as the above-mentioned allotted number data, and is data indicating a number of the virtual prizes currently being allotted to the player terminal(s) 4. The allottable number can be derived by subtracting the allotted number data from the stock number data.

FIG. 6 shows the relationship between the stock number indicated by the stock number data, the allotted number indicated by the allotted number data, and the allottable number derived therefrom.

===Construction Example of a System Utilizing the Internet===

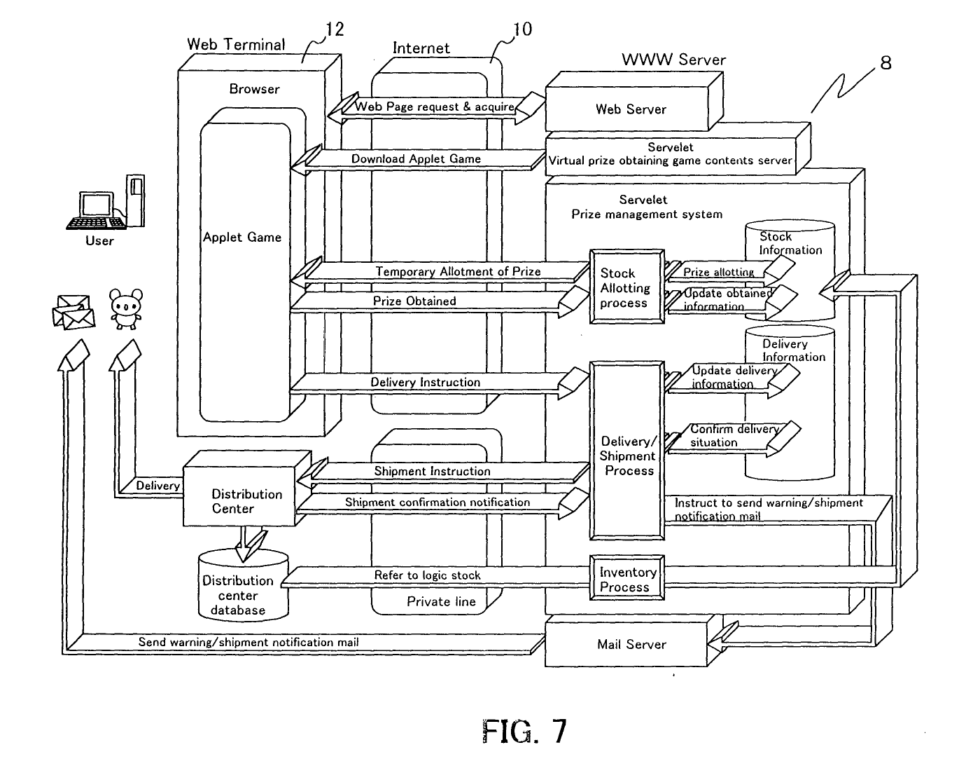

Hereinbelow is one embodiment of constructing a prize-obtaining game system utilizing the communication network according to the present invention by utilizing the Internet. FIG. 7 schematically shows the construction of this system.

This system is structured by: a WWW server 8 which functions as the host computer of the present invention; and many Web terminals 12 functioning as the player terminals of the present invention and connected to the server via the Internet 10. The Web terminal 12 may be any communication terminal that is connectable to the Internet 10, and includes, for example, a personal computer in the respective homes, and mobile communications terminal such as a portable telephone or a PDA comprising communication control means. The WWW server 8 is a server set on the WWW (World Wide Web), namely the Internet 10, and provides various information in respect to the Web terminal 12 which accesses via the Internet 10, and provides a service of various virtual games. The server is managed as a game site.

A person who wants to play the virtual prize-obtaining game initiates the Web browser installed in the Web terminal 12, accesses the WWW server 8 via the Internet 10 using this Web browser, and acquires a homepage of the relevant WWW server 8. A login screen is acquired from this homepage, a predetermined authentication procedure is performed by sending his/her own user ID and password to the WWW server 8, a procedure is performed to specify a payment method of, for example, a game charge, and data for structuring the screen of a game-selection page is acquired. The game-selection page is prepared with a virtual prize-obtaining game for every combination of prizes. A game player, a person who wants to play the game, selects the virtual prize-obtaining game that he/she wants to play out of these virtual prize-obtaining games, and clicks on a part of the virtual prize-obtaining game. The Web terminal 12 sends information necessary for executing the game, such as a prize combination code or a game code specifying the kind of game regarding the virtual prize-obtaining game that game player has chosen, to the WWW server 8.

The WWW server 8 receives information from the Web terminal 12, and based on the received game code, a corresponding predetermined virtual prize-obtaining game program, as in the form of, for example, a Java Applet (registered trademark), is transmitted towards the Web terminal 12. Further, based on the prize combination code from the Web terminal 12, the WWW server 8 reads the data corresponding to the code from a prize combination code chart prepared in advance. In this code chart, the prize combinations and the necessary amount of prizes are registered in advance, with the prize combination code as the key. For example, for code 1, data of a combination of prizes C and D with seven as a necessary amount of prizes is registered, whereas for code 2, a combination of prizes E, F, and G with ten as a necessary amount of prizes is registered. The WWW server 8 refers to this prize combination list, and acquires information relating to the kind and the necessary amount of the virtual prize of the virtual prize-obtaining game chosen by the game player.

The WWW server 8 sets the actual allotted number of the virtual prize based on these information. Specifically it is performed as follows. First, based on the kind of the virtual prize in the virtual prize-obtaining game selected by the game player, the allottable number for each kind of the respective prizes is calculated. From the stock-management database, the total supply number data of the actual prize corresponding to the virtual prize, the already-obtained number data, and the allotted number data currently allotted are read out. Then, the allottable number is calculated based on these data.

Then, the WWW server 8 performs allotting of the virtual prizes based on these calculated allottable numbers for each kind of prize, so that those with larger allottable numbers are allotted more as virtual prizes, or, the various kinds of prizes are respectively fairly distributed and equally allotted.

First, the WWW server 8 confirms whether the allottable number of the virtual prize is “0” (zero) or not. When there is a prize with the allottable number of “0” (zero), the virtual prize-obtaining game chosen by the game player is made so that the game cannot be executed, and the allotting process is halted. When there are no prizes with an allottable number of “0” (zero), the prize is allotted one by one so each prize is evenly distributed regardless of the respective kind. When the remaining necessary amount does not reach the number of the kind of prizes, the allottable number of each prize is referred to, and the prizes are allotted one by one in order from the prize with a large allottable number. For example, if the necessary amount of the prize is seven, and the number of the kinds of prizes is three, two are allotted for each kind of prize, and further, the prize with the largest allottable number out of the three kinds of prizes is increased by one to be three. Further, if the necessary amount of the prizes is twelve, and the number of the kinds of prizes is five, two are allotted for each kind of prize, and the number of the prize with the largest allottable number out of the five kinds of prize, and the number of the prize with the next largest allottable number are respectively increased by one to be three.

The WWW server 8 stores information relating to the kind and amount of the allotted virtual prize as a log in a storage section, taking a user ID of the person who wants to play the virtual prize-obtaining game as a key, and sends towards the Web terminal 12 a game-start-permit information permitting the start of the virtual prize-obtaining game using the virtual prize. At this time, the WWW server 8 attaches, to the game-start-permit information, information relating to a storage area of an image data of the allotted virtual prize so that the Web terminal 12 may acquire the image data of the allotted virtual prize. Namely, the WWW server 8 comprises a database which stores the image data of the virtual prize for each kind of the virtual prize, and which may be accessed from external sources via the Internet. The Web terminal 12 acquires image data of the allotted virtual prize from the database, based on information relating to the storage area of the image data of the virtual prize sent from the WWW server 8.

The Web terminal 12 displays a game image including the image of the virtual prize on a displaying screen of the display means, based on the image data sent from the WWW server 8 corresponding to the virtual prize, in accordance with the virtual prize-obtaining game program sent in advance, so the game player may enjoy the virtual prize-obtaining game.

When the virtual prize-obtaining game ends, the Web terminal 12 sends a game-end notification including the result of prize obtainment in the game of the player and the user ID of the player towards the WWW server 8.

The WWW server 8 adds and updates the obtained number, which is acquired from the obtained-number information included in the game-end notification sent from the Web terminal 12, to the already-obtained number data of the stock-management database. Further, based on the user ID sent together with the game-end notification, the WWW server 8 refers to the above-mentioned log content, and retrieves data of the kind and number of the allotted prize related with the user ID and eliminates these data from the log. Further, the WWW server 8 subtracts the actual allotted number from the allotted number and updates the allotted number data, and cancels the allotment of the virtual prizes actually allotted to the virtual prize-obtaining game.

Further, the WWW server 8 sends towards the Web terminal 12 an input screen of information relating to the delivery destination of the prize, such as an address, a name, and a telephone number of the destination, and acquires information relating to the delivery destination of the prize by requesting to the prize obtainer to input the prize destination information, or, by making the player specify information relating to the destination in advance. Then, the WWW server 8 registers these acquired information together with information relating to the kind of prize obtained by the player to the prize delivery database. At the prize delivery center, the delivery process of the actual prizes is carried out, based on the information registered in the prize delivery database. The prizes with the delivery process finished are registered one by one as delivery complete in the prize delivery database. The delivery progress of the prizes are sent to each player via electronic mail or the like.

### INDUSTRIAL APPLICABILITY

According to a prize-obtaining game system utilizing the communication network and a host computer and a player terminal for a prize-obtaining game for this system according to the present invention, since the host computer connected by the communication network to the many player terminals is made to allot the virtual prizes successively in respect to the player terminals which access, even if many player terminals simultaneously access the host computer, there is no problem that the obtained prize is out of stock or is sold out. Thus, even in a virtual prize-obtaining game, a situation where the obtained prize cannot be received can be prevented, and the obtained prize can be surely provided to the player. A game similar to a prize-obtaining game of such as a catcher game machine provided in a game center or the like may be enjoyed by, for example, a personal computer. Moreover, since the game may be freely enjoyed anywhere at anytime regardless of the location, the prize-obtaining game may be fairly enjoyed anywhere without a regional difference.

1. A prize-obtaining game system utilizing a communication network, said system comprising a host computer connected to many player terminals in a manner mutually capable of communicating therewith via said communication network, said player terminal executing a virtual prize-obtaining game program, and said system providing to players an actual prize corresponding to a virtual prize obtained by said players in said virtual prize-obtaining game, wherein:
(11) said host computer comprises:
a stock-management database to which stock information of said actual prize is registered, and
virtual-prize allotting means for allotting a predetermined number of said virtual prize successively to said player terminal which accessed said host computer, based on said stock information registered to said stock-management database;
(12) said stock information includes:
stock number data indicating a stock number of said actual prize that can be provided to said player, and
allotted number data indicating a number of said virtual prize which is currently being allotted to said player terminal;
(13) when said host computer receives a game-start notification from said player terminal, said host computer determines whether or not said virtual prize is allottable to said player terminal based on a number of said virtual prize currently allottable, said number being calculated based on said stock number data and said allotted number data; and
when it is determined to be allottable,
said host computer sends game-start-permit information to said player terminal in order to respond to said player terminal; and
said virtual-prize allotting means updates said allotted number data registered to said stock-management database according to a number of said virtual prize to be allotted to said player terminal; and
(14) when said host computer receives a game-end notification from said player terminal, said virtual-prize allotting means acquires
information relating to a number of said virtual prize obtained by said player in said virtual prize-obtaining game executed at said player terminal, and
information relating to a number of said virtual prize allotted to said player terminal, and
updates said stock number data and said allotted number data in said stock-management database based on these two kinds of information.

2. A prize-obtaining game system utilizing a communication network, said system comprising a host computer connected to many player terminals in a manner mutually capable of communicating therewith via said communication network, said player terminal executing a virtual prize-obtaining game program, and said system providing to players an actual prize corresponding to a virtual prize obtained in said virtual prize-obtaining game, wherein:
(21) said host computer comprises:
a stock-management database for managing a stock of said actual prizes, and
virtual-prize allotting means for allotting a predetermined number of said virtual prize successively in respect to said player terminal which accessed said host computer based on stock information of said actual prizes recorded in said stock-management database;
said stock information including
a total supply number data and an already-obtained number data of said actual prize, and
an allotted number data indicating a current allotment as a virtual prize in respect to said player terminal;
(22) said host computer successively receives a game start notification from said player terminal; and
when said host computer receives said start notification, said host computer:
refers to said stock information of said stock-management database;
with said virtual-prize allotting means, calculates an allottable number of said virtual prizes which may be allotted in respect to said virtual prize-obtaining game which is executed at said player terminal based on said total supply number data, said already-obtained number data of said actual prize, and said allotted number data;
sets a predetermined number which is equal to or less than said allottable number as an actual allotted number;
transmits game-start-permit information permitting a start of said virtual prize-obtaining game according to said actual allotted number of said virtual prizes, in order to respond to said player terminal; and
adds said actual allotted number at this time to said allotted number data and updates the same; and
(23) said host computer successively receives from said player terminal a game-end notification including
obtained-number information of said virtual prizes obtained in said virtual prize-obtaining game executed at said player terminal, and
information for specifying said actual allotted number set at a start of said game; and
when said game-end notification is received, said host computer
adds said obtained number to said already-obtained number data of said stock-management database and updates the same with said virtual-prize allotting means, and
subtracts said actual allotted number from said allotted number to update said allotted number data.

3. A prize-obtaining game system utilizing said communication network according to claims 1 or 2, wherein said host computer notifies said player terminal not to start a game, when said allottable number is 0.

4. A prize-obtaining game system utilizing a communication network according to any of claims 1 to 3, wherein
a plurality of kinds of said actual prizes are prepared,
stock information of said respective kinds is recorded respectively in said stock-management database, and
a game-start-permit notification is sent to said player terminal when
said host computer allots at least one kind of said virtual prize in respect to said virtual prize-obtaining game executed at said player terminal, and
allotting of said virtual prize of at least one kind is possible.

5. A prize-obtaining game system utilizing a communication network according to any of claims 1 to 4, wherein said host computer comprises means for storing information relating to a kind and amount of an allotted virtual prize in respect to said virtual prize-obtaining game executed at each of said player terminal, taking a player ID of each player or a terminal ID of each player terminal which are set in advance as a key.

6. A prize-obtaining game system utilizing a communication network according to any of claims 1 to 5, wherein said host computer comprises a function of sending a program of said virtual prize-obtaining game to said respective player terminal via said communication network.

7. A prize-obtaining game system utilizing a communication network according to any of claims 1 to 6, wherein said host computer comprises:
means for acquiring information necessary for delivery of said prize such as a name, an address, and a telephone number of said player who has obtained said prize; and
means for registering said information in a prize delivery database.

8. A prize-obtaining game system utilizing a communication network according to any of claims 1 to 7, wherein:
said host computer is a Web server arranged on the Internet; and
said player terminal is a Web terminal connectable to the Internet and in which a browser software enabling browsing of information browsable on the Internet is installed.

9. A host computer for a prize-obtaining game, which is used as said host computer in a prize-obtaining game system utilizing a communication network according to either one of claims 1 to 8.

10. A player terminal for a prize-obtaining game, which is used as said player terminal in a prize-obtaining game system utilizing a communication network according to either one of claims 1 to 8.
